(19) United States
(12) Patent Application Publication
(10) Pub. No.: US 2004/0182645 A1
(43) Pub. Date: Sep. 23, 2004

(54) System for safe descent of people or cargoes

(76) Inventor: Yuriy ShterenBerg, Needham, MA (US)

Correspondence Address: ShterenBerg Yuriy, 184 Linden St, apt D, Needham, MA, 02492, US

(21) Appl. No.: 10/389,894

(22) Filed: Mar. 17, 2003

(51) Int. Cl. A62B 1/00

(52) U.S. Cl. 182/11

(57) ABSTRACT

The system for safe descent of people or cargoes, for example for rescuing people in case fire in high-rise buildings consists of a device for control movement along the cable, the cable itself and a connection between them. There is no need for any serious preparation before using the system: the cable by means of hanging device or without them is dropped downwards or the cable is discharged from the cross bow to the lower object where the harpoon fixes itself. The control over the speed of the descent is performed automatically by means of electric frictional brake. Required energy is used from energy weight of descending object. The rotor of a generator of direct current and the axis of the movable disk of the brake is connected with the axis of the contact disk through the reducer. Three revolutions of the cable are reeled upon this contact disk. Such connection ensures rolling of the contact disk along the cable without sliding So the control over the rotation speed of the contact disk is the control over the speed of the descent of the device onto which a person is fastened. the generator feeds the reel of the solenoid. The movable disk of the brake with anchor of solenoid overcome adjusting spring and press to the immobile disk so that the prescribed speed of the descent is maintained. To perform both descent and ascent the device is supplied with a accumulator while instead of the generator a convertible unit generator-engine is installed. So while ascending the accumulator is connected to the generator-engine unit working as an engine. The manual drive of the brake allows to make additional or emergent slowing down.

### BACKGROUND OF THE INVENTION

The development of systems and devices for rescuing people from roofs and upper-floors of the buildings on fire along the outer part of these buildings counts back many years. The most important condition for the successful rescuing operation is the control over the descent speed so that injuries during landing be not possible. The examples are such prior ar systems and devices as US Pat. Nos. 6,371,244; 6,223,868; 6,182,789; 6,085866; 5,842,542; 5,145,036; 4,934,484; 4,705,142; 4,679,654; 1,190,389.

The prior art systems and devices have a number of substantial drawbacks. Some of them use the physical force from the person descending what limits the number of people who can use the device (old people, kids and handicapped people are excluded). Other use a outer source of energy and the demand for a stable electric power supply is difficult to provide for in fire.

The prior art device U.S. Pat. No. 5,586,617 instead of the outer source of energy uses the energy of the weight of the descending person and it is a great advantage of this device. Under the influence of this power the drum with the cable onto which a descending person is fixed is reeled. A hydraulic device is attached to the axis of the drum and the rotating of the drum makes this device absorb some energy of the descending body by pumping some liquid by the pump. But among the drawbacks of the device one has to mention the necessity to install it provisionaly in the potentially dangerous buildings. Its size makes it impossible to use when rescuing from an apartment or an office on the upper floors of buildings. Second, one person attaches to the cable and for next the cable has to be reeled upon the drum manually unplugging the hydraulic device. Third, the device can work only with vertically dropped cable that is sometimes a person must descend along the wall of the building on fire It can be dangerous or even impossible. And finally, the device cannot be used to lift cargoes or people, for example, firemen to carry out some works in the building on fire.

It has been reported by the media recentely that in Israel they created a system for rescuing people from the roofs of the buildings on fire. According to the report in case of fire people descend to the ground from a special hose on the roof that has been installed with a container beforehand. People enter one by one that hose and slide down to the ground while slowing down is ensured by some steps inside the hose. The presence of such system on the roof of a building solves the problem of rescuing a significant number of people in case a container or containers have been installed above the walls that are not on fire at the moment. The developers of the system report that it takes much time to install such a system. Taking into consideration its probable price it is difficult to suppose that most high-rise buildings can be provided with such system in the near future.

That is why the development of mobile, inexpensive and easily-assembled systems for individual or group rescuing is still important. It also essential that neither the physical force nor the outer energy supply, nor the trained personnel be involved in operating such a system. The task of separating the descending person from the wall on fire with the necessity of lifting firemen or some cargoes upwards are also important

The proposed gives the answer to these questions.

### BRIEF SUMMARY OF THE INVENTION

A proposed system for safe descent of people or cargoes is the answer to the problem of mobile, cheap and easily assembled system for a person or group being rescuing from the upper floors and roofs of high-rise buildings on fire. To control the speed of the descent here there is no need in neither physical efforts nor in outer source of energy nor preinstalled stationary mechanisms. A cable is used here as a channel of movement. In place of descend an easily-assembled hanging device is installed. All parts of it, tubes and a stopping drum about which a cable is wound, are included in the standard complete shipping set of the system. In case of special emergency the upper end of the cable is just fixed upon some strong object on the roof or in the apartment without handing device. The cable with a weight on its end is dropped vertically downwards until it touches the soil or under special conditions can be stretched out obliquely. For this purpose the free end of the cable is fixed on a harpoon with self-fixation mechanism built-in and the crossbow with a gun-sight is charged with the harpoon. The crossbow is discharged in safe direction to the roof of a lower building or the empty patch of ground, on reaching which the harpoon fixes itself safely and then the axes of the drum with left of cable stops. So it is possibile to separate the person who descends from the wall of the building. All the elements of the system controlling the speed of the descent are in the device for control movement along the cable. A descending person puts on belts of the device in the form of a knapsack. The person connects the contact disk of the device with the cable and then he or she can leave the roof or the upper floor himself or herself, without extra assistance.

The cable is reeled upon the gutter of contact disk three revolutions and, additionally, the cable is inserted into the unclosing ring of the stabilizing lever which freely rotates on the axis of the contact disk. This connection of the device with cable provides the rolling of the contact disk both along the vertical or inclined cable without sliding. So the control speed of descent is made by control rotation speed of the contact disk by means electrical frictional brake. For this reason, the hard conjunction between contact disk's speed and speed of direct current generator and speed of axis of the movable disk of the brake is realized by reducer. The energy of descending person's weight is transformed into electrical energy by the generator of direct current. The safety manual drive of the brake also can be used. The presence of such system in the personal or group property will make it possible for people living or working on the high floors to rescue themselves, the members of their family and staff either by getting to the roof of the building or immediately from their apartment or office.

Several canal-cables can operate simultaneously. Along each of them people with devices can descend one after another. After lowering these devices can be lifted upwards in the container along one of the cables. For this purpose the same connecting the device with the cable is used while a power battery is added to the device. Such a functionally extended device for controlf movement along the cable can be also used for lifting people to a significant height. For example, if such device is shipped with the usual automobile accumulator the max height of the ascent of the cargo weighing 150 kg can be up to 200 meters at a speed of 0.5 m/sec. So the proposed can be used in mining, steeplejacking, rescuing people, in war, in show business, and in sport.

### BRIEF DESCRIPTION OF THE SEVERAL VIEWS OF THE DRAWINGS

FIG. 1a and FIG. 1b are schematic views showing the devices for vertical and inclined cable correspondingly in accordance with the present invention,

FIG. 2 is a schematic view of self fastening harpoon of the present invention,

FIG. 3 is schematic projections of the main variant of the device for control movement along the cable in accordance with the present invention,

FIG. 4 is a schematic drawing of the frictional brake of the present invention,

FIG. 5 is a schematic projection of the alternative variant of the device for control movement along the cable,

FIG. 6 is a schematic trajectory of the harpoon's movement and a stretched inclined cable,

FIG. 7 is a schematic view of connection a cable with the device for control movement along the cable,

FIG. 8 is characteristic curves of the stabilization of descent's speed.

### DETAILED DESCRIPTION OF THE INVENTION

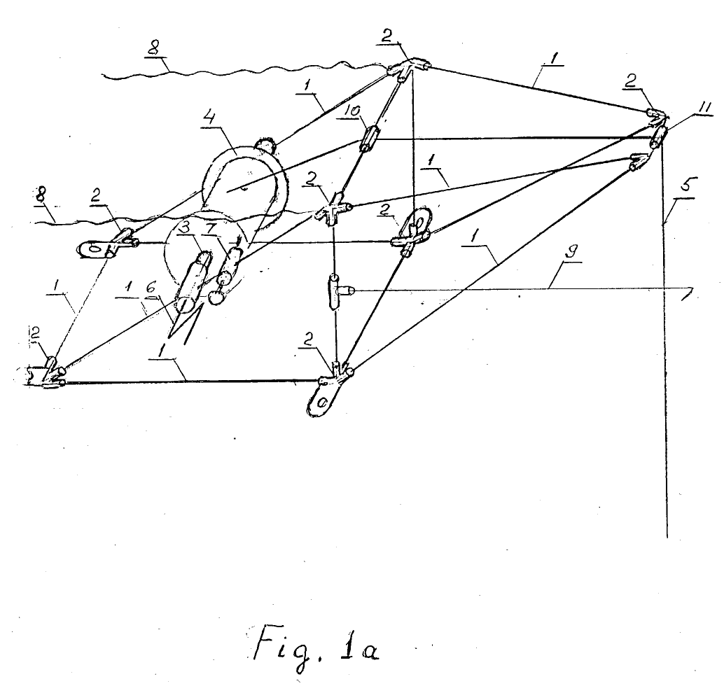

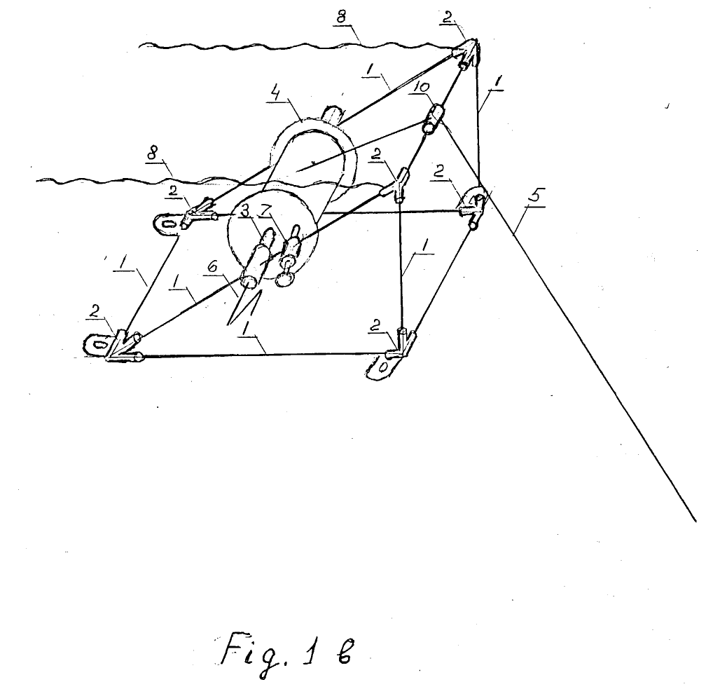

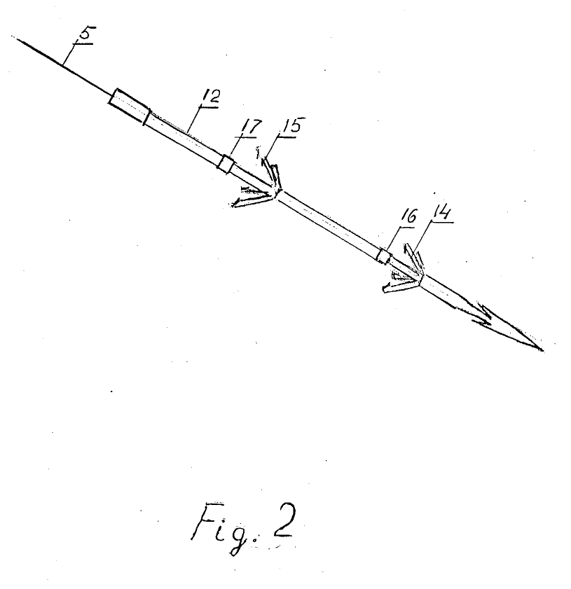

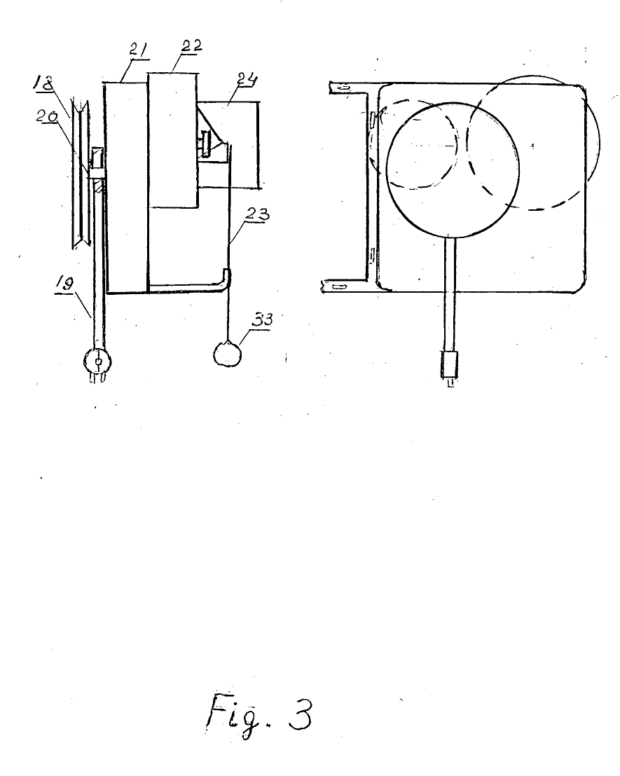

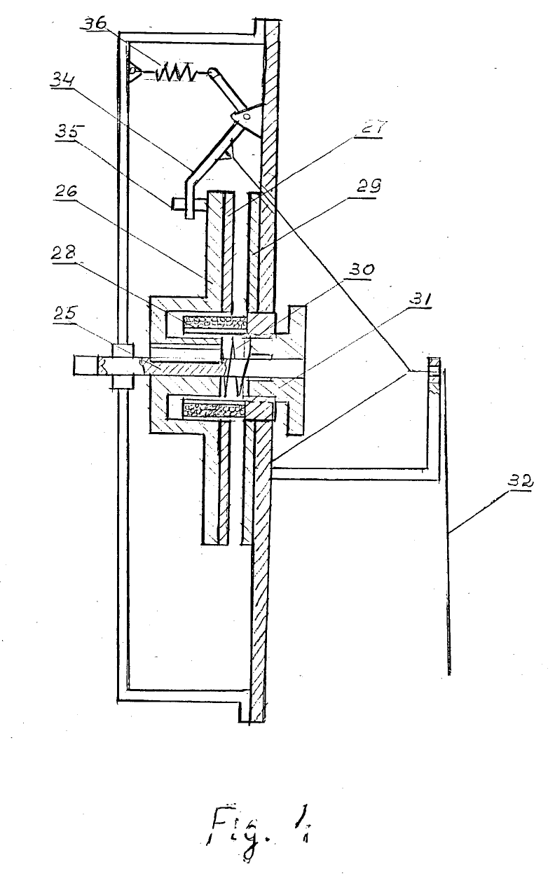

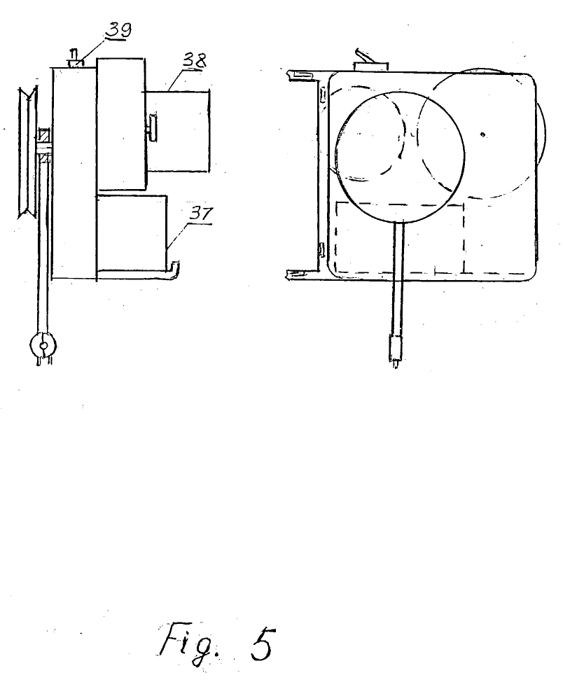

A preferred embodiment of a system for safe descent of people or cargoes of the present invention is illustrated in FIG. 1a, FIG. 1b, FIG. 2, FIG. 3, FIG. 4.

The hanging device on the FIG. 1a or FIG. 1b is installed on the roof of a building on fire or any upper floor of the same building near the window. Both devices are consist of the pipes 1, plugs 2, two half-axes 3 for the drum 4 with the cable 5, a handle 6, a stopper 7 and stretching 8. All these elements are included in the standard complete set of this system. In case of a vertically dropped cable (FIG. 1a) the device is assembled in toto, which includes the frontal part that ensures some distance between the cable and the wall of the building and a controlling lever 9 for hoisting up the upper part of the dropped cable to the descending person for connection. In special case the upper end of the cable without the hanging device is just fixed upon the strong constructions on the roof or in the apartment. In case of an inclined cable (FIG. 1b) only the main part of the hanging device should be assembled. Both types of the device are fixed by crutches or self-cut bolts through stop bearing on some part of the roof or the floor, while stretching which are connected to some strong pieces of the roof or of the floor so the device is additionally secured from incline and moving.

The cable 5 made out of heatproof steel veins, supple, light and strong, is reeled in advance upon the drum 4, that easily revolves along the half-axes 3. It is thrown over the revolving plugs 10 and 11 (FIG. 1a) or through the plug 11 only (FIG. 1b). The steel harpoon 12 (FIG. 2) that the cross-bow 13 is charged with is used in case of inclined cable fitted for. It has sharpened barbed head and special hook for self-fixation 14 and 15. Opening of the grip-hooks is constrained by the rings 16 and 17.

FIG. 3 shows the schematic composition of a variant of the device for control movement along the cable that provides the safe descent of a person along the cable. The device functionally consists of a contact disk 18, stabilizing lever 19 with the handle unclosing ring, a working axis 20, a reducer 21, a electrical frictional brake 22, a manual drive of these brakes 23 and a generator of direct-current 24.

FIG. 4 shows a schematic variant of the frictional brake. An anchor of a solenoid 26 is installed on an axis 25 of the brake and makes one unit with the movable disk 27 of the brake. It revolves together with the axis 25 and can shift along this axis under influence of a reel of the solenoid 28′ magnetic field. The reel is connected to the output of the generator. The revolving movable disk is attracted to the immobile disk 29 thus creating the effect of braking. An adjusting spring 30 hinders contacting the disks. The force of counteraction of spring is regulated by an adjusting bolt 31, which is scaled in kg (pounds) of a weight of the descending person. The movable disk can approach to the immobile one also under the influence of the manual drive. It consists of a cable 32 with a ring 33, three levers 34 with rollers 35 and springs 36. The levers are pressed to the outer surface of the moveable disk through the rollers by the springs.

the magnetic field of generator of direct current 24 is criated of stable magnets.

The reducer, while functioning as a base of the device, increase the speed of the rotation of the moveable brake's disk and the rotor of the generator to the rotation's speed of the contact disk. Here the applicant prefers to set the coefficient of the transmission as 16 to 1.

As another variant of the device for control movement along the cable is a device that allows (apart from the descending procedures) to perform an ascension of a person or cargoes to a substantial altitude. The schematic variant of such device is shown on the FIG. 5. The device now includes the accumulator 37, while the generator of direct current is substituted with a convertible unit engine generator 38. While ascending the connection of the

accumulator to the unit working as an engine is performed through the switcher 39.

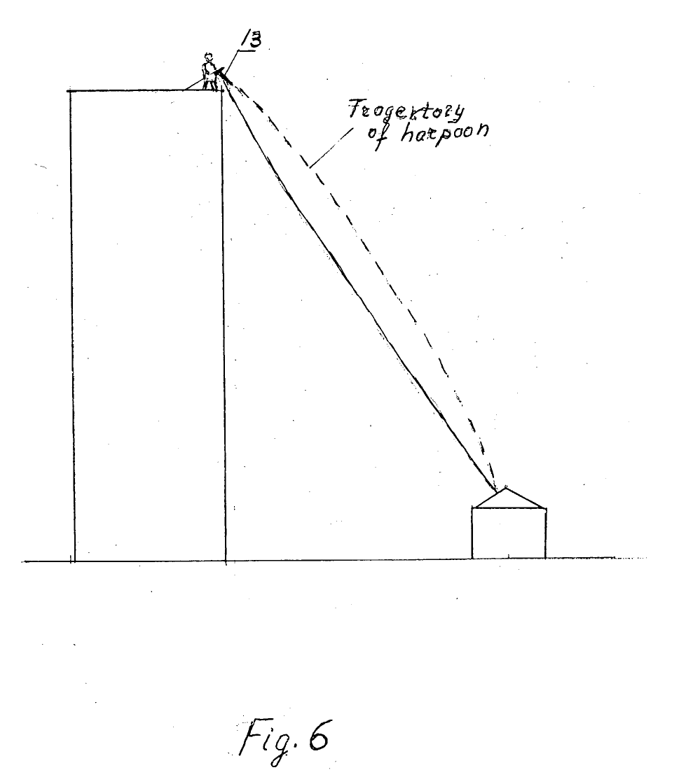

In case of vertical descent a weight of about 2-4 kg is fixed on the end of the cable, the cable is lowered down till it almost reaches the ground but so that the weight would strain the cable. After this the drum is stopped and the hanging device is ready for use. The descent along the inclined cable is possible only in case there is a lower building with penetrable roof at the side of the wall at a distance of 50-100 meters or just a free spot. In this case the end of the cable hanging from the hanging device is fixed upon the harpoon 12, the harpoon is charged into the cross-bow 13 with a gun-sight and discharged into the intended target. On the harpoon's reaching the dense soil's layer the ring 16 is displased and the grip hooks 14 open, while on reaching the attic premises the ring 17 also is displaced and the grip hooks 15 open also. On reaching the target the drum is pressed by the stopper 7 and the inclined cable is ready for use. The trajectory of the harpoon's movement and the stretched inclined cable is shown on the FIG. 6.

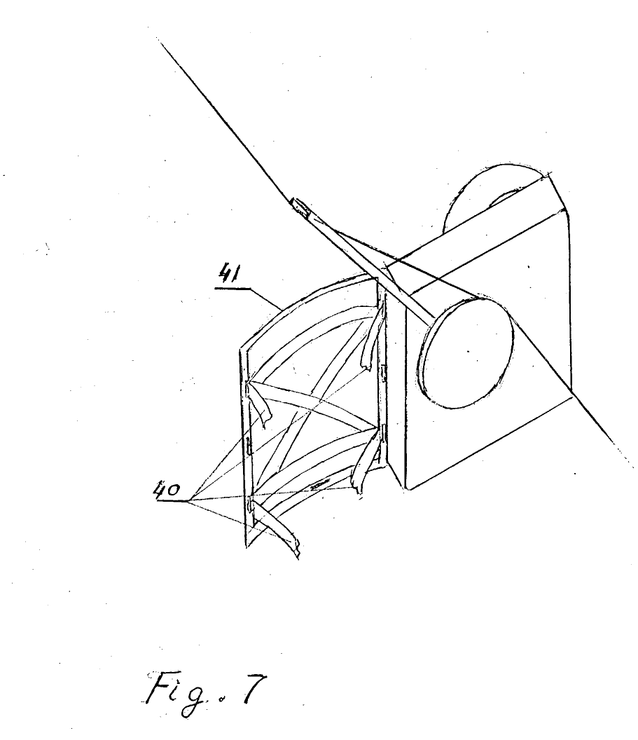

The descending person puts on the device for control movement along the cable using the belts 40 with fasteners of the frame 41 of the device (FIG. 7). Then he or she comes to the hanging device so that the hanging part of the cable will be on the left hand from the person, and clamps the device for control movement along cable to the cable. For this purpose he or she makes three tight revolutions of the cable on the gutter of the contact disk, while the cable on the right hand he or she inserts into the unclosing ring of the stabilizing lever 19. The stabilizing lever, which freely rotates on the axis 20, protects the person from contacting the cable, and in case of the inclined cable also prevents the turning of the device at 180 degree. After this the person comes to the edge of the roof (or the window) and leaves it.

In the described connection of the device with the cable the control the speed of rotation the contact disk is the control speed of downward movement of a person because the contact disk rolls along the cable without sliding.

It is used here to ensure the safety of the descent by stabilizing the rotation speed of the contact disk.

After the person starts moving along the cable the speed of rotating of the contact disk increases under the influence the gravity from 0 to a prescribed level 0.5 m/sec very soon [in 0.05 sec]. At the same time the value of tension at the output of the generator being proportional to the speed of the rotating of its rotor is increased. It reaches that value at which the magnetic field of the solenoid overcomes the resistance of the adgusting spring and presses the moveable disk to the immobile one. The process stabilizing of the speed of the descent starts.

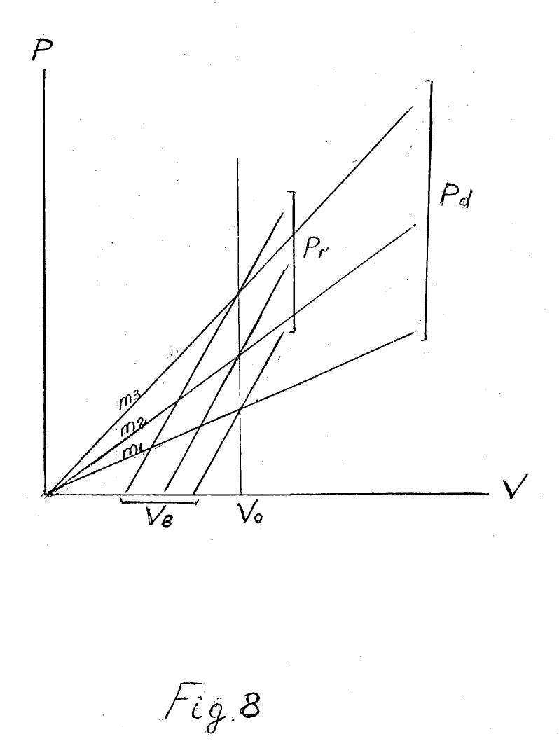

To ensure of the maintaining the prescribed speed the process of controlling should be administered by the dependencies given in the FIG. 8 Here there are the dependency of the power of the downward movement Pd and the power of braking Pr from the speed of the descent V. The virtual dependency Pr[V] is determined by the particular characteristics of the frictional brake. But it is obvious, that Pr grows monotonously with the increase of the speed and so we conventionally define this dependency in working range of the speed as linear. To stability of control it is necessary, first, that the curvedness of the Pr be bigger than the curvedness of the Pd and, second, the dependency Pr[V] must be displaced regarding zero[to ensure the crossing of these dependencies in the defined dot Vo and speed Vb at which the disks of the brake start contacting each other]. This is attained by the introduction into the brake the adjusting spring 30 and adjusting bolt 31 The speed Vb is determined by the weight m of the descending object. On the FIG. 8 the characteristics of the movement and the braking are given for three different weights m3, m2, m1, while m3>m2>m1.

If the speed of the descent is less than V₀ then the power of the descent movement is bigger than the power of the braking and the movement quickens. Otherwise if V>V₀ than the power of the descent movement is less than the power of braking and the movement slows down. Hence the stabilization of the descent speed is ensured.

The descending person has to apply some effort while using the manualdrive of brake for an extra and emergency slowing down. In this case the cable

32 turns the levers 34 which press the movable disk 27 to the immobile disk 29 using the rollers 35.

On reaching the targeted plane of the descent the person unfastens the belts, frees himself from the device and unplugs the device from the cable.

The connection of the contact disk with the cable when the disk rolls along the cable whatever the angle of the cable could be makes the possibility of lifting a person or some cargoes to a significant altitude.

If the device for control movement along the cable is shipped with an usual automobile accumulator the limitation of possible altitude is over than 200 m.

Just like in case of descent a person fastens the belts of the device and inserts the cable into the unclosing ring of the stabilizing lever. Then one fixes on the end of the cable the cargo weighing 2-4 kg so that it just would touch the ground and makes three revolutions of the cable along the gutter of the contact disk in the direction indicated by the arrow. To start the movement one should turn the switcher 39 ON and the unit, engine-generator 38, working as an engine connect up to the accumulate 37r. The contact disk starts rotating and “rolling” up the cable. The ascending person would like to slow down movement at the end of ascent by using the manual drive of the brake, as it was described above. The upper end of the cable can be fixed both on stable and slowly moving object.

What I claim as my invention is:

1. A system for safe descent of people or cargoes, comprising:
1) A device for control movement along the cable, wherein contact disk is connected via reducer with axis of moveable disk of frictional brake and with rotor of a generator of direct current which feeds the reel of a solenoid that shifts its anchor with said moveable disk to a immobile disk of said frictional brake, and by means of an adjusting spring and scaled by weight of a descending person adjusting bolt start of contacting of said disks is offset regarding zero speed of the descent.
2) A connection between said device for control movement along the cable and said cable provide prescribed number of rotations of said cable around said contact disk while said cable is under pressure of a weight that is less than a weight of descending object in 50-100 times.
3) A device for oblique stretching of said cable includes a cross bow and a self-fixation harpoon, whose discharging mechanism releases a grip hooks as said harpoon penetrates into solid layers of aiming object.
4) A device for control movement along the cable that perform ascending apart from descending and comprising in addition of claims 1 power battery while instead of said generator a convertible unit engine-generator is installed so when ascending said power battery is connected to said unit operating as an engine.
1. A safety manual drive of said frictional brake comprising
a governing cable and a mechanism for pressing said moveable disk to said immobile independently from the main regime of operating of said brake.
